(19) United States
(12) Patent Application Publication
(10) Pub. No.: US 2018/0150786 A1
(43) Pub. Date: May 31, 2018

(54) EFFICIENT TASK PLANNING USING PAST PERFORMANCE

(71) Applicant: Microsoft Technology Licensing, LLC, Redmond, WA (US)

(72) Inventors: Shoubhik Debnath, Los Angeles, CA (US); Fiona Khatana, Gurgaon (IN); Subhankar Ghosh, Kolkata (IN)

(21) Appl. No.: 15/364,081

(22) Filed: Nov. 29, 2016

(51) Int. Cl. G06Q 10/06; G06Q 10/10

(52) U.S. Cl. CPC G06Q 10/063114; G06Q 10/06398; G06Q 10/103

(57) ABSTRACT

In an embodiment task description information for tasks that are to be performed by developers is accessed. Performance information related to the tasks that are to be performed by the developers is accessed. The task description information and the performance information is analyzed to determine current performance estimation parameters that are indicative of how current instances of the tasks should be performed by the developers. The current performance estimation parameters are then output.

### BACKGROUND

In a developer environment, utilizing the developers efficiently is the key to improve their productivity and team's performance overall. Presently, senior members assign work items to developers mostly based on intuition. Hence, the estimated time set by senior members within which the work item needs to complete may be inaccurate, resulting in either overloading or under-utilizing the developer.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments disclosed herein are related to systems, methods, and computer readable medium for the efficient planning for the performance of one or more tasks of an overall project that members of a project team are to complete when implementing the project. In one embodiment, a computing system includes a first database that stores task description information for various tasks that are to be performed by various developers and a second database that stores performance information related to the various tasks that are to be performed by the developers. The computing system also include a processor and system memory. The computing system instantiates in the system memory a first module that access the task description information from the first database, accesses the performance information from the second database, and analyzes the task description information and the performance information to determine current performance estimation parameters that are indicative of how current instances of the one or more tasks should be performed by the developers. The computing system instantiates in the system memory a second module that outputs the current performance estimation parameters.

In another embodiment task description information for tasks that are to be performed by developers is accessed. Performance information related to the tasks that are to be performed by the developers is accessed. The task description information and the performance information is analyzed to determine current performance estimation parameters that are indicative of how current instances of the tasks should be performed by the developers. The current performance estimation parameters are then output.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing system in which the principles described herein may be employed;

FIG. 2 illustrates an embodiment of an environment and computing system that is able to efficiently plan for the performance of one or more tasks of an overall project that members of a project team are to complete when implementing the project;

FIG. 3 illustrates an embodiment of developer information;

FIG. 4 illustrates an embodiment of developer past performance information;

FIGS. 5A-5D illustrate an example embodiment of the operation of a time prediction module;

FIGS. 6A-6D illustrate an example embodiment of the operation of a task allocation module;

FIGS. 7A-7D illustrate an example embodiment of the operation of a project plan module; and

FIG. 8 illustrates a flow chart of an example method for the efficient planning for the performance of one or more tasks of an overall project that members of a project team are to complete when implementing the project.

### DETAILED DESCRIPTION

In a typical project planning, the project is broken into a set of tasks that are then completed to achieve the overall purpose of the project. The set of tasks may then be assigned to various developers by a manger, supervisor, or the like to perform. The manager will typically assign a task to the developer that he or she feels is best suited to perform the task. In addition, the manager will provide an estimated time that he or she feels will be sufficient for the developer to complete the task.

However, the task assignment is often based on the manager intuition. Accordingly, the developer who is assigned to perform the task may not actually be the best suited as the developer may not have as much experience as another possible developer or the difficulty level of the task may be too much for the developer. Said another way, there may be a better choice of developer for the task that the manager may not readily be aware of.

In addition, the estimated time set by the manager may not be sufficient for the developer to complete the task. This may lead to dissatisfaction by the developer and the manager. Conversely, the estimated time may be more than is needed, in which case the task and overall project may not be performed as efficiently as possible.

Advantageously, the embodiments disclosed herein provide for systems, methods and computer readable media t for the efficient planning for the performance of one or more tasks of an overall project that members of a project team are to complete when implementing the project. In one embodiment, a computing system includes a first database that stores task description information for various tasks that are to be performed by various developers and a second database that stores performance information related to the various tasks that are to be performed by the developers. The computing system also include a processor and system memory. The computing system instantiates in the system memory a first module that access the task description information from the first database, accesses the performance information from the second database, and analyzes the task description information and the performance information to determine current performance estimation parameters that are indicative of how current instances of the one or more tasks should be performed by the developers. The computing system instantiates in the system memory a second module that outputs the current performance estimation parameters.

In another embodiment task description information for tasks that are to be performed by developers is accessed. Performance information related to the tasks that are to be performed by the developers is accessed. The task description information and the performance information is analyzed to determine current performance estimation parameters that are indicative of how current instances of the tasks should be performed by the developers. The current performance estimation parameters are then output.

There are various technical effects and benefits that can be achieved by implementing aspects of the disclosed embodiments. By way of example, it is now possible to efficiently assign tasks to developers based in part on their experience and on their past performance in performing similar tasks with similar difficulty. In addition, it is now possible to use the past performance to more efficiently predict the actual amount of time that will be needed to complete the task. Moreover, it is possible for a manager to learn how well he or she estimates time needed for completion of the tasks. Further, the technical effects related to the disclosed embodiments can also include improved user convenience and efficiency gains.

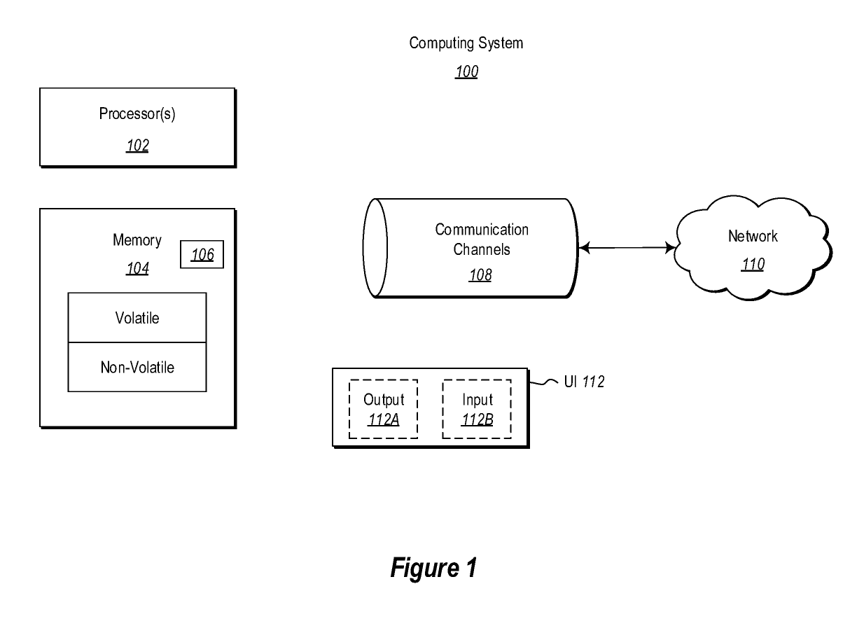

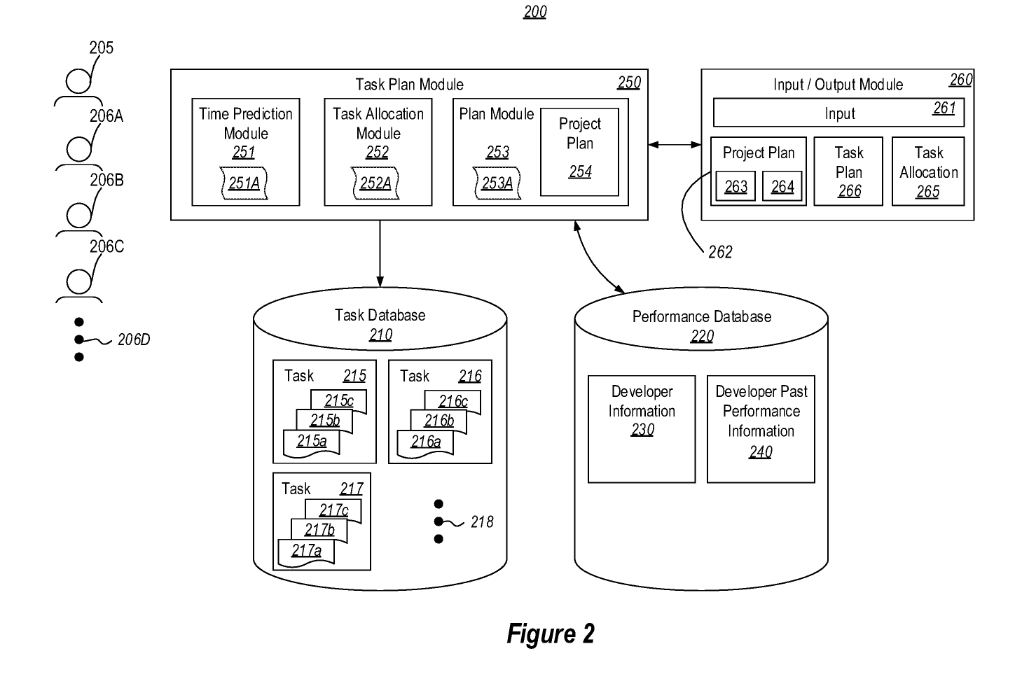

Some introductory discussion of a computing system will be described with respect to FIG. 1. Then, systems and methods for the efficient planning for the performance of one or more tasks of an overall project that members of a project team are to complete when implementing the project will be described with respect to FIG. 2 through FIG. 8.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Attention is now given to FIG. 2, which illustrates an embodiment of an operational environment 200 including a computing system 201, which may correspond to the computing system 100 previously described. The computing system 201 includes various components or functional blocks that may implement the various embodiments disclosed herein as will be explained. The various components or functional blocks of computing system 201 may be implemented on a local computing system or may be implemented on a distributed computing system that includes elements resident in the cloud or that implement aspects of cloud computing. The various components or functional blocks of the computing system 201 may be implemented as software, hardware, or a combination of software and hardware. The computing system 201 may include more or less than the components illustrated in FIG. 2 and some of the components may be combined as circumstances warrant. Although not necessarily illustrated, the various components of the computing system 201 may access and/or utilize a processor and memory, such as processor 102 and memory 104, as needed to perform their various functions.

As illustrated in FIG. 2, the operational environment 200 may include a task assigner 205. The task assigner 205 may be a manger, supervisor, project lead, or the like who assigns various tasks 215-217 for a current project as will be explained in more detail to follow. The tasks may be assigned to one or more developers 206a, 206b, 206c, and any number of additional developers as illustrated by the ellipses 206d. The developers may be collectively referred to hereinafter as “developers 206”. The developers 206 may be the actual workers who will perform the tasks as will also be described in more detail to follow.

The operational environment 200 and computing system 201 may include or otherwise have access to a task database 210. The task database may be a store or the like that stores task descriptions for the tasks that are to be performed by the developers 206. For example, the task database 210 may include a description of a task 215. As shown, the task 215 may include various task description information that is related to the task 215. For example, the task may include task description information 215a that specifies what type of task the task 215 is. In one embodiment, the task 215 may be a User Interface (UI) task type, although this not required as the task 215 may be any reasonable task type. The task 215 may also include task description information 215b that specifies the difficulty level of the task. In one embodiment, the difficulty level may be specified as a range from 0 to 1, with 0 being the least difficult and 1 being most difficult. Of course, the difficulty level may be specified in other reasonable ways. In one embodiment, the difficulty level of the task is determined based on an estimated amount of time it would take to complete the task, with a longer estimated time being indicative of a more difficult task level. The task 215 may also include task description information 215c that may specify any other information that may be used in assigning the task 215 to one or more of the developers 206 as will be explained in more detail to follow.

The task database 210 may also include a description of a task 216. As shown, the task 216 may include various task description information that is related to the task 216. For example, the task 216 may include task description information 216a that specifies what type of task the task 216 is. In one embodiment, the task 216 may be a Middle Tier (MT) task type, although this not required as the task 216 may be any reasonable task type. The task 216 may also include task description information 216b that specifies the difficulty level of the task. As with the task 215, the difficulty level may be specified as a range from 0 to 1, although the difficulty level may be specified in other reasonable ways. The task 216 may also include task description information 216c that may specify any other information that may be used in assigning the task 216 to one or more of the developers 206.

Likewise, the task database 210 may further include a description of a task 217. As shown, the task 217 may include various task description information that is related to the task 217. For example, the task 217 may include task description information 217a that specifies what type of task the task 217 is. In one embodiment, the task 217 may be a Database (DB) task type, although this not required as the task 217 may be any reasonable task type. The task 217 may also include task description information 217b that specifies the difficulty level of the task. As with the task 215, the difficulty level may be specified as a range from 0 to 1, although the difficulty level may be specified in other reasonable ways. The task 217 may also include task description information 217c that may specify any other information that may be used in assigning the task 217 to one or more of the developers 206. The database 210 may also include any number of additional task with their corresponding task description information as illustrated by ellipses 218.

The operational environment 200 and computing system 201 may also include or otherwise have access to a performance database 220. The performance database 220 may be a store or the like that stores information related to the task assigner 205 and the developers 206. In addition, the performance database 220 may store information related to past performance of the assigner 205 in assigning one or more of the tasks 215-218 and the developers 206 in performing one or more of the tasks 215-218. It will be appreciated that although the task database 210 and performance database 220 are shown in the figures are being separate, this need not be the case as it is also possible for both databases to the same database.

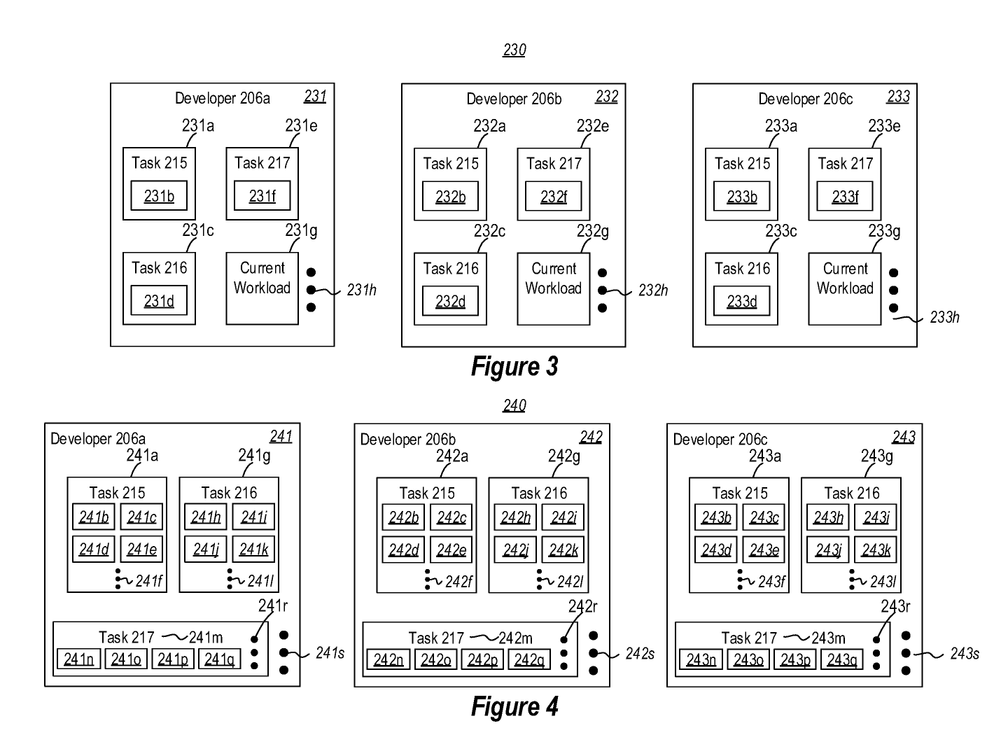

For example, the performance database 220 may include developer information 230 that specifies information such as the experience level that each of the developers 206 has for a given task 215-218 and the current workload of the developers. FIG. 3 illustrates an embodiment of developer information 230. The developer information 230 may be an example of performance information that is related to the previous performance of the tasks 215-218.

As illustrate in FIG. 3, the developer information 230 includes developer 206a information 231. The developer 206a information 231 may include information 231a that specifies an experience level 231b that the developer 206a has for the task 215. The experience level 231b details how much past work experience the developer 206a has had in working on the task 215. The experience level may be determined based on a scale from 0 to 1 in a manner similar to the difficulty level of the task previously described. In such embodiments, an experience level that is similar to the difficulty of the task may indicate that the developer 206a has sufficient experience to perform the task 215 in a reasonable manner. In other embodiments, the experience level may be determined or at least inferred by the number of times that the developer 206a has performed the task 215. Thus, a developer 206a who has performed task 215 large number of time would have a relatively large experience level 231b while a developer who had only performed task 215 a small number of times or perhaps not at all would have a relatively small experience level 231b. In still other embodiments, the experience level 231b may be determined in other reasonable manners.

The developer 206a information 231 may also include information 231c that specifies an experience level 231d that the developer 206a has for the task 216 and information 231e that specifies an experience level 231f that the developer 206a has for the task 217. The experience information 231d and 231f may be determined in the manner previously described for the experience information 231b.

In some embodiments, the developer 206a information 231 may also include information 231g that specifies the current workload of the developer 206a. In such embodiments, the current workload information 231g may provide an insight into to how available the developer 206a is for additional tasks that the assigner 205 may desire to assign to the developer 206. The ellipses 231h illustrate that the developer 206a information 231 may include additional information related to the developer 206a as circumstances warrant.

The developer information 230 may also include developer 206b information 232 and developer 206c information 233. The information 232 and 233 corresponds to the developer 206a information 231 and thus it is not necessary to provide additional discussion on the operation of the elements of the information 232 and 233. Accordingly, the developer 206b information 232 may include information 232a that specifies an experience level 232b that the developer 206b has for the task 215, information 232c that specifies an experience level 232d that the developer 206b has for the task 216, information 232e that specifies an experience level 232f that the developer 206b has for the task 217, information 232g that specifies the current workload of the developer 206b and additional information 232h. The developer 206c information 233 may include information 233a that specifies an experience level 233b that the developer 206c has for the task 215, information 233c that specifies an experience level 233d that the developer 206c has for the task 216, information 233e that specifies an experience level 233f that the developer 206c has for the task 217, information 233g that specifies the current workload of the developer 206c and additional information 233h. Although not illustrated, the developer information 230 may also include developer information for any additional developers 206d.

Returning to FIG. 2, the performance database 220 may include developer past performance information 240 that specifies information such as the estimated time and the actual time to complete a given task 215-218. The developer past performance data 240 may also specify bug fix time and the assigner 205 who assigned the task to the developer 206. FIG. 4 illustrates an embodiment of developer past performance information 240. The developer past performance information 240 may be an example of performance information that is related to the previous performance of the tasks 215-218.

As illustrated in FIG. 4, the developer past performance information 240 includes developer 206a past performance information 241 that specifies information 241a about how the developer 206a has performed the task 215. The information 241a may include information 241b that specifies the estimated time that the developer 206a was given to perform the task 215 one or more times in the past. The estimated time is typically the time that the assigner 205 feels that the developer 206a should need to complete the task 215 given the developer 206a's expertise. The estimated time information 241b may be entered into the performance database 220 by the developer 206a and/or the assigner 205 any time the developer is assigned to perform the task 215, although is some embodiments it may be entered by another party or entity.

The information 241a may include information 241c that specifies the actual time that the developer 206a took to perform the task 215 one or more times in the past. The actual time information 241c for a given performance of the task 215 may correspond to an estimated time information 241b for the given performance of the task. The actual time information 241c may be entered into the performance database 220 by the developer 206a and/or the assigner 205 anytime the developer 206a performs a given task 215, although is some embodiments it may be entered by another party or entity.

The information 241a may also include information 241d that specifies the time the developer 206a took to perform bug fixes for the completed tasks 215. As will be appreciated, in many instances one or more bugs will occur in a completed task 215 that will require the developer 206a to fix. The time that it takes complete the bug fix for a given task 215 may therefore be included in the information 241d. The information 241d may be entered into the performance database 220 by the developer 206a and/or the assigner 205 anytime the developer 206a performs a bug fix, although is some embodiments it may be entered by another party or entity.

In some embodiments, it may be useful to know the assigner 205 who assigned the various tasks 215 as this may change. Accordingly, the information 241a may also include information 241e that specifies who the assigner 205 was for each task 215 that was assigned. The ellipses 241f illustrate that the information 241a may also include other reasonable information related to the past performance of the task 215 as circumstances warrant.

The developer 206a past performance information 241 may also include information 241g about how the developer 206a has performed the task 216. The information 241g may include information 241h that specifies the estimated time that the developer 206a was given to perform the task 216 one or more times in the past in the manner previously described for information 241b. The information 241g may include information 241i that specifies the actual time that the developer 206a took to perform the task 216 one or more times in the past in the manner previously described for information 241c. The information 241g may also include information 241j that specifies the time the developer 206a took to perform bug fixes for the completed tasks 216 in the manner previously described for information 241d. The information 241g may also include information 241k that specifies who the assigner 205 was for each task 216 that was assigned. The ellipses 2411 illustrate that the information 241g may also include other reasonable information related to the past performance of the task 216 as circumstances warrant. The various information may be entered into performance database 220 by the developer 206a and/or the assigner 205, although is some embodiments it may be entered by another party or entity.

The developer 206a information past performance 241 may also include information 241m about how the developer 206a has performed the task 217. The information 241m may include information 241n that specifies the estimated time that the developer 206a was given to perform the task 217 one or more times in the past in the manner previously described for information 241b. The information 241m may include information 2410 that specifies the actual time that the developer 206a took to perform the task 217 one or more times in the past in the manner previously described for information 241c. The information 241m may also include information 241p that specifies the time the developer 206a took to perform bug fixes for the completed tasks 217 in the manner previously described for information 241d. The information 241m may also include information 241q that specifies who the assigner 205 was for each task 217 that was assigned. The ellipses 241r illustrate that the information 241m may also include other reasonable information related to the past performance of the task 217 as circumstances warrant. The ellipses 241s illustrate that the developer 206a information 241 may include other reasonable information, such as developer 206a information related to the performance of one or more additional tasks 218. The various information may be entered into performance database 220 by the developer 206a and/or the assigner 205, although is some embodiments it may be entered by another party or entity.

The developer past performance information 240 may also include includes developer 206b past performance information 242 and developer 206c past performance information 243. The information 242 and 243 corresponds to the developer 206a past performance information 241 and thus it is not necessary to provide additional discussion on the operation of the elements of the information 242 and 243. The various information in the performance database 220 for the developer 206b past performance information 242 and developer 206c past performance information 243 may be entered by the developer 206a and/or the assigner 205, although is some embodiments it may be entered by another party or entity.

The developer 206b past performance information 242 may include information 242a about how the developer 206b has performed the task 215. The information 242a may include information 242b that specifies the estimated time that the developer 206b was given to perform the task 215 one or more times in the past, information 242c that specifies the actual time that the developer 206b took to perform the task 215 one or more times in the past, information 242d that specifies the time the developer 206b took to perform bug fixes for the completed tasks 215, information 242d that specifies who the assigner 205 was for each task 215 that was assigned. The ellipses 242f illustrate that the information 242a may also include other reasonable information related to the past performance of the task 215 as circumstances warrant.

The developer 206b past performance information 242 may include information 242g about how the developer 206b has performed the task 216. The information 242g may include information 242h that specifies the estimated time that the developer 206b was given to perform the task 216 one or more times in the past, information 242i that specifies the actual time that the developer 206b took to perform the task 216 one or more times in the past, information 242j that specifies the time the developer 206b took to perform bug fixes for the completed tasks 216, information 242k that specifies who the assigner 205 was for each task 216 that was assigned. The ellipses 2421 illustrate that the information 242g may also include other reasonable information related to the past performance of the task 216 as circumstances warrant.

The developer 206b past performance information 242 may include information 242m about how the developer 206b has performed the task 217. The information 242m may include information 242n that specifies the estimated time that the developer 206b was given to perform the task 217 one or more times in the past, information 242o that specifies the actual time that the developer 206b took to perform the task 217 one or more times in the past, information 242p that specifies the time the developer 206b took to perform bug fixes for the completed tasks 217, information 242q that specifies who the assigner 205 was for each task 217 that was assigned. The ellipses 242r illustrate that the information 242m may also include other reasonable information related to the past performance of the task 217 as circumstances warrant. The ellipses 242s illustrate that the developer 206b information 242 may include other reasonable information, such as developer 206b information related to the performance of one or more additional tasks 218.

The developer 206c past performance information 243 may include information 243a about how the developer 206c has performed the task 215. The information 243a may include information 243b that specifies the estimated time that the developer 206c was given to perform the task 215 one or more times in the past, information 243c that specifies the actual time that the developer 206c took to perform the task 215 one or more times in the past, information 243d that specifies the time the developer 206c took to perform bug fixes for the completed tasks 215, information 243d that specifies who the assigner 205 was for each task 215 that was assigned. The ellipses 243f illustrate that the information 243a may also include other reasonable information related to the past performance of the task 215 as circumstances warrant.

The developer 206c past performance information 243 may include information 243g about how the developer 206c has performed the task 216. The information 243g may include information 243h that specifies the estimated time that the developer 206c was given to perform the task 216 one or more times in the past, information 243i that specifies the actual time that the developer 206c took to perform the task 216 one or more times in the past, information 243j that specifies the time the developer 206c took to perform bug fixes for the completed tasks 216, information 243k that specifies who the assigner 205 was for each task 216 that was assigned. The ellipses 2431 illustrate that the information 243g may also include other reasonable information related to the past performance of the task 216 as circumstances warrant.

The developer 206b past performance information 242 may include information 243m about how the developer 206c has performed the task 217. The information 243m may include information 243n that specifies the estimated time that the developer 206c was given to perform the task 217 one or more times in the past, information 243o that specifies the actual time that the developer 206c took to perform the task 217 one or more times in the past, information 243p that specifies the time the developer 206c took to perform bug fixes for the completed tasks 217, information 243q that specifies who the assigner 205 was for each task 217 that was assigned. The ellipses 243r illustrate that the information 243m may also include other reasonable information related to the past performance of the task 217 as circumstances warrant. The ellipses 242s illustrate that the developer 206c information 243 may include other reasonable information, such as developer 206c information related to the performance of one or more additional tasks 218.

Returning to FIG. 2, the environment 200 and computing system 201 may include a task plan module 250. In operation, the task plan module 250 may access or receive task description information from the task database 210 and the performance information 230 and 240 from the performance database. The task plan module is may then determine, based on the task description information and the performance information 230 and 240 one or more current performance estimation parameters. The current performance estimation parameters provide information that indicates how the various tasks 215-215 should be performed so that the tasks are performed in an efficient and optimum manner. There may be any number of types of current performance estimation parameters as circumstances warrant. Specific embodiments of the operation of the task plan module 250 and its modules 251, 252, and 253 will be given in more detail to follow.

The task plan module 250 may include a time prediction module 251 that is able to predict a completion time for one or more of the tasks 215-218 for a given developer 206 based in part on the past performance of the developer 206. The predicted completion time, shown at 251a, may be an example of a current performance estimation parameter.

The task plan module 250 may also include a task allocation module 252 that is able to allocate one or more of the tasks 215-218 to the one or more developers 206 who are best suited to perform the task based in part on the past performance and the experience level of the developers 206. The allocation of the one or more developers 206 who are best able to perform the task, shown at 252a, may be an example of a current performance estimation parameter.

The task plan module 250 may further include a project plan module 253 that is able to, for a given set of tasks 215-218, allocate the set of tasks to a group of the developers 206 who are best able to perform them based in part on difficulty of the tasks, the past performance, and the availability of the developers 206. The allocation of the set of tasks to the one or more developers, shown at 253a, may be an example of a current performance estimation parameter.

In some embodiments, the project plan module 253 may include or otherwise have access to a project plan 254. The project plan 254 may be a plan that is provided by the assigner 205 or some other source that specifies an overall project or the like that is comprised of the set of tasks 215-218. Said another way, the project plan 254 defines the tasks 215-218 that need to be completed by the developers 206 in order to achieve the overall purpose of the project behind the project plan 254. The project plan module 253 may then use the project plan 254 as a guide to determine which tasks need to be allocated to the developers 206 who are best able to perform them as will be described in more detail.

The environment 200 and computing system 201 may also include an input/output module 260. The input/output module 260 may include an input element 261 that represents the various user interface elements that can be accessed by a user, typically the assigner 205, to input data that will result in the task plan module 250 performing its operation as will be described in more detail to follow. The output module may output an estimated time 262 including an assigner's bias 263 and bug fix time 264, a task allocation 265, and a project allocation plan 266 as will be described in more detail to follow.

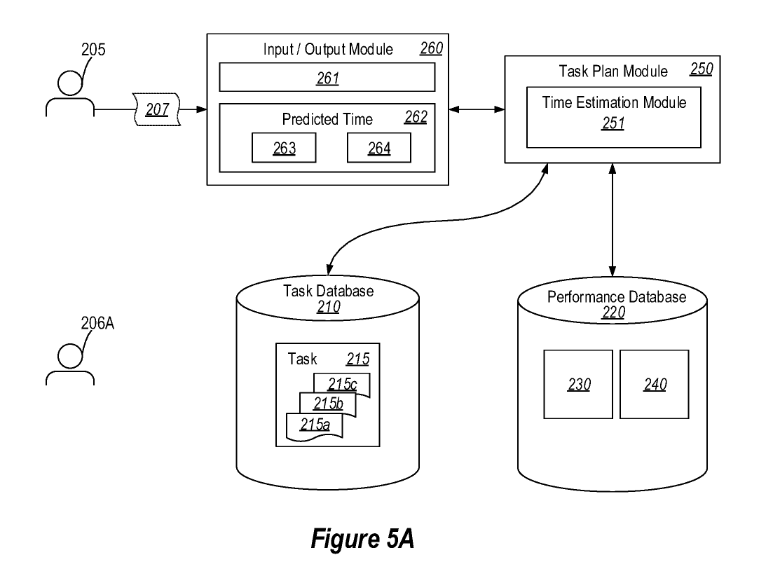

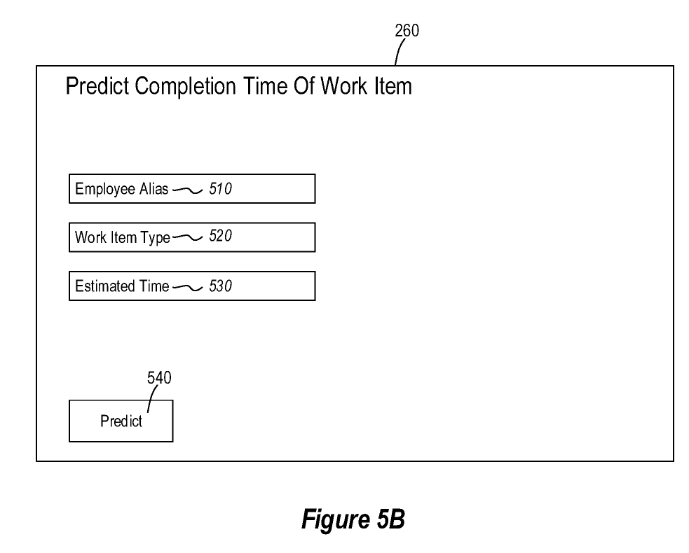

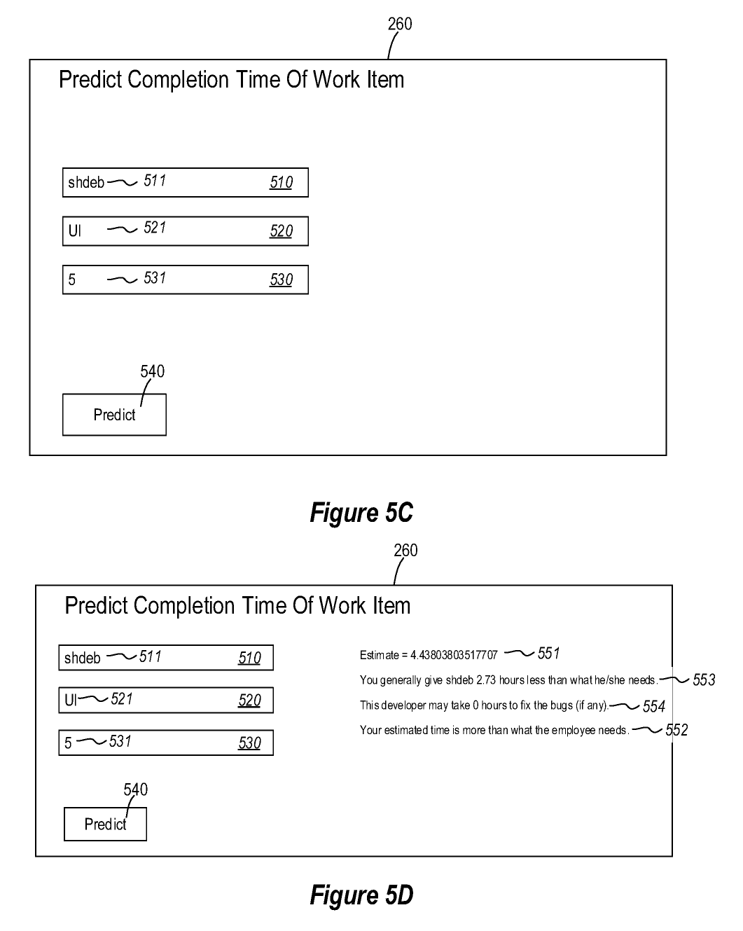

FIG. 5A illustrates an embodiment of the operation of the task plan module 250 in predicting an amount of time that should be allocated for the performance of a task. FIG. 5A illustrates a portion of the environment 200 and computing system 201 shown in FIGS. 2-4 and not all the details of those figures are included for ease of explanation.

As shown in FIG. 5A, the assigner 205 may desire to determine the actual amount of time that should be allocated to the developer 206a to complete the task 215. In addition, the assigner 205 may desire to find out if the time that he or she estimates should be required to complete the task 215 is reasonable. Accordingly, the assigner 215 may provide input 207 into the input element 261. In this embodiment, the input 207 may specify the identity of the developer 206a using a name, alias, company ID or some other reasonable identifier for the developer 206a. The input may also identify the task or the task type, which in the embodiment is assumed to be task 215, and may also provide an estimated amount of time that the assigner 205 believes should be required to complete the task.

The input element 261 may then provide the input 207 to the task plan module 250, specifically to the time prediction module 251. The time prediction module 251 may then access or receive the task description information 215a, 215b, and 215c from the task database 210. The time prediction module 251 may also access or receive some of the developer 206a information 231 and the developer 206a past performance information 241 from the past performance database 220.

The time prediction module 251 may then determine, based on the task description information 215a, 215b, and 215c and the performance information 231 and 241, a predicated time that it should take the developer 206a to complete the task 215. For example, the time prediction module 251 may analyze the task description information 215a, 215b, and 215c and determine the difficulty level of the UI task 215. In addition, the time prediction module 251 may analyze the developer information 231a to determine the experience level 231b of the developer 206a.

The time prediction module 251 may also analyze the past performance information 241a to determine the estimated time 241b and the actual time information 241c for all the instances of the task 215 that the developer 206a has performed in the past. The information 241c may also be used to determine the identity of the assigner 205 who assigned the various tasks 215 in the past. The time prediction module 251 may also access the bug fix information 241d and any other of the performance information 241a as needed.

The time prediction module 251 may then analyze the accessed information to determine a predicted time that the developer 206a should need to perform the task 215. For example, the time prediction module 251 may compare the experience level of the developer 206a against the difficulty level of the task. In addition, the time prediction module 251 may compare the estimated time with the actual completion times. It will be appreciated that the time prediction module 251 may perform any reasonable operation, algorithm, or the like to determine the predicted time (and to determine a bug fix time and bias as will be discussed in more detail to follow). It will be appreciated that the predicted time is an example of a performance estimation parameter 251a. The predicted time may be output and displayed on a UI of the input/output module 260 as predicted time 262.

In some embodiments, the time prediction module 251 may also determine an expected bug fix time. In such embodiments, the time prediction module 251 may analyze the bug fix information 241d to determine how often the developer 206a has needed to perform a bug fix for a given past 215 having similar difficulty and time allotments as the current task 215. The time prediction module 251 may then predict any needed bug fix time, which may be an example of a current performance estimation parameter. This may be may be output and displayed on a UI of the input/output module 260 as bug fix 263.

In still other embodiments, the time prediction module 251 may determine a bias of the assigner 205 when making estimations of the required time for the developer 206a to perform the task 215. The bias specifies whether the assigner estimates too much or too little time when assigning a task 215 to the developer 206a. The time prediction module 251 may use the information 241e, the developer information 231a, and the past performance data 241a to determine the bias. For example, the time prediction module 251 may compare the estimated times for each task 215 that the assigner 205 assigned to the developer 206a to the actual time that that was needed to complete the task for a task having similar difficulty level and experience level of the developer to determine the bias. If the estimated time is generally more than the actual time, then the assigner 205 may be estimating too much time. Conversely, if the estimated time is generally less than the actual time, then the assigner 205 may be estimating too little time. The bias allows the assigner 205 to learn how well he or she is at estimating time needed to complete the task 215. The bias, which may be an example of a current performance estimation parameter, may be may be output and displayed on a UI of the input/output module 260 as bias 264.

Attention is now given to FIGS. 5B-5D, which illustrate an embodiment of the input/output module 260 and the operation of the time prediction module 251. As illustrated in FIG. 5B, the input/output module 260 include various input elements 261. For example, the figure includes an element 510 for inputting a developer 206a identifier, an element 520 for inputting a type of the task 215, and an element 530 for inputting the estimated time to complete the task. An element 540 is used to cause the time prediction module 251 to determine the predicted time.

FIG. 5C shows an example of the assigner 205 inputting the input 207 into the input/output module 260. For example, an identifier for the developer 206a, in this case his or her alias “shdeb” is input as shown at 511. In addition, UI is input as the type of task 215 as shown at 521. Further, 5 hours is input as the amount of estimated time as shown at 531. The assigner 205 may then activate the element 540 to cause the time prediction module 251 to determine the predicted time.

As shown in FIG. 5D, the time prediction module 251 may determine the predicted or estimated time in the manner previously described. In the embodiment, this is shown as 4.43 (rounded) as denoted at 551. It will be appreciated that predicted time 551 is an example of a predicated time 262 and is also an example of a current performance estimation parameter. Since the estimated time 531 was 5 hours, which is more than the predicted time 551 of 4.43 hours, the time prediction module 251 may inform the assigner 205 that his or her estimate is more time than the developer 206a needs as denoted at 552.

As mentioned previously, the time prediction module 251 may also determine any bug fix time and an assigner 205 bias. As shown in FIG. 5D, the time prediction module 251 may determine a bias 263 that indicates that the assigner 205 generally estimates too little time for the developer 206a. For example, here the assigner typically estimates 2.73 hours less than what developer 206a would typically need as denoted at 553. In addition, as denoted at 554, in the illustrated embodiment time prediction module 251 does not determine that any bug fix time 264.

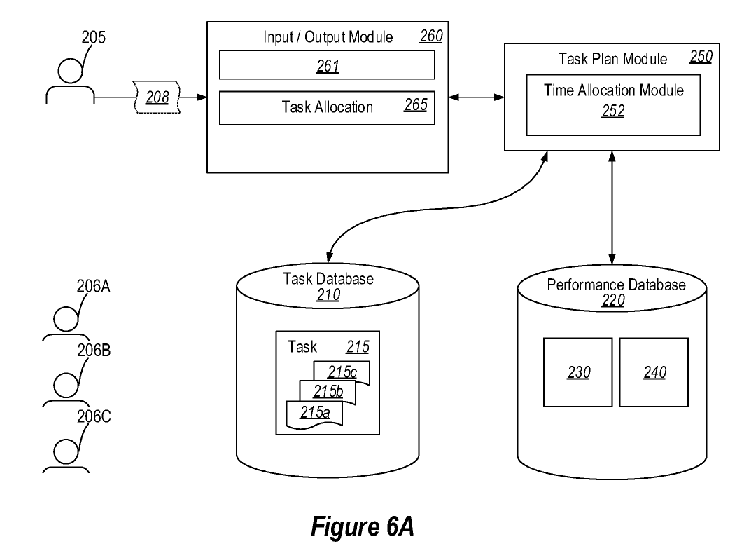

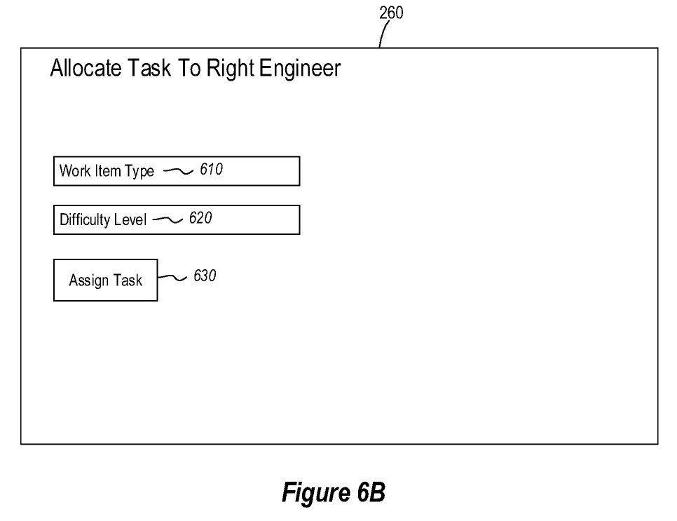

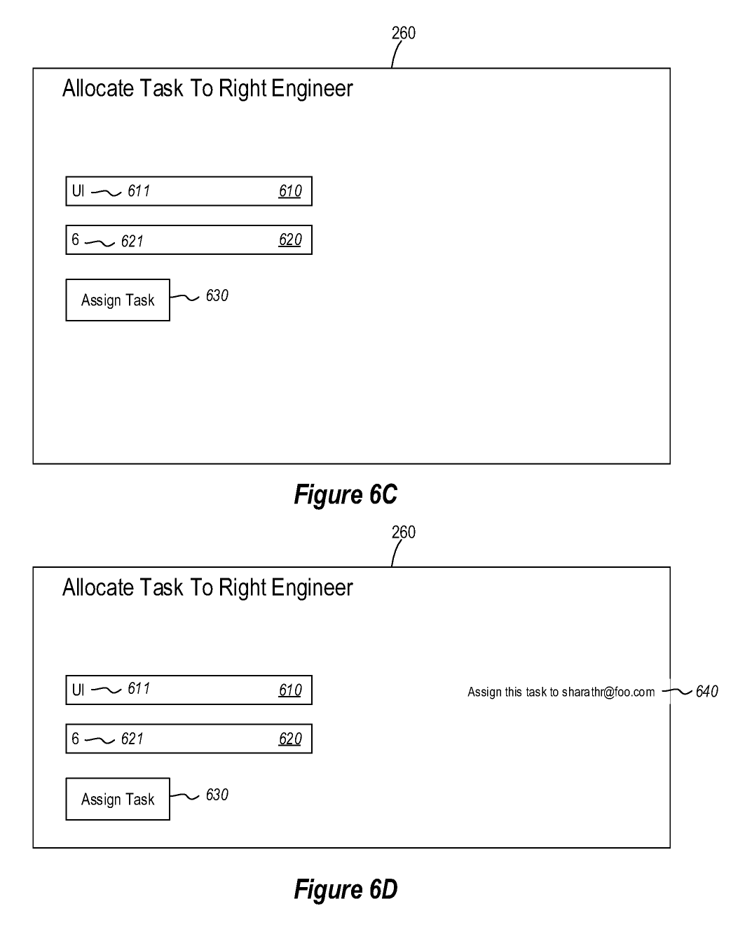

FIG. 6A illustrates an embodiment of the operation of the task plan module 250 in allocating one or more of the tasks 215-218 to one or more developers 206 who are best suited to perform the task based in part on the past performance and the experience level of the developers 206. FIG. 6A illustrates a portion of the environment 200 and computing system 201 shown in FIGS. 2-4 and not all the details of those figures are included for ease of explanation.

As shown in FIG. 6A, the assigner 205 may desire to determine the best developer 206a suited to perform a task given the difficulty level of the task. Accordingly, the assigner 205 may provide input 208 into the input element 261. In this embodiment, the input 208 may identify the task or the task type, which in the embodiment is assumed to be task 215, and may also provide an estimated difficulty level for the task.

The input element 261 may then provide the input 208 to the task plan module 250, specifically to the task allocation module 252. The task allocation module 252 may then access or receive the task description information for the type of task specified in the input 208 from the task database 210. In the embodiment, since the task type is task 215, the information 215a, 215b, and 215c may be accessed or received. The task allocation module 252 may also access or receive the developer information 230 and the developer past performance data 240 for each of the developers 206.

The task allocation module 252 may then compare or otherwise analyze the developer information 230 and the developer past performance information 240 in view of the work type and its difficulty. In this way, the task allocation module 252 is able to determine those developers 206 that have the expertise level and/or the past experience to perform the task 215 with the specified difficulty. The task allocation module 252 may then further determine that the one developer 206 who has the most past experience in performing the task 215 with the specified difficulty is the best suited to currently perform the task. The task allocation module may also access the current workload information of the best suited developer 206 to ensure that this developer is currently able to take on a new or additional task assignment. It will be appreciated that the task allocation module 252 may perform any reasonable operation, algorithm, or the like to determine the developer 206 who the task should be allocated to.

The determination of the developer 206 who the task 215 should be allocated to is an example of current performance estimation parameter. As shown in FIG. 6A, the developer 206 who the task 215 should be allocated to may be output and displayed on a UI of the input/output module 260 as task allocation 265.

Attention is now given to FIGS. 6B-6D, which illustrate an embodiment of the input/output module 260 and the operation of the task allocation module 252. As illustrated in FIG. 6B, the input/output module 260 include various input elements 261. For example, the figure includes an element 610 for inputting a type of the task 215, and an element 620 for inputting a difficulty level for the task 215. An element 630 is used to cause the task allocation module 252 to determine the developer 206 who the task 215 should be allocated to.

FIG. 6C shows an example of the assigner 205 inputting the input 208 into the input/output module 260. For example, UI is input as the type of task 215 as shown at 611. Further, 0.6 is input as the difficulty level as shown at 621. The assigner 205 may then activate the element 630 to cause the task allocation module 252 to determine the developer 206 who the task 215 should be allocated to.

As shown in FIG. 6D, the task allocation module 252 may determine the developer 206 who the task 215 should be allocated to in the manner previously described. In the embodiment, the developer is shown as “sharathn@foo.com” as denoted at 640. This is an example of the task allocation 265.

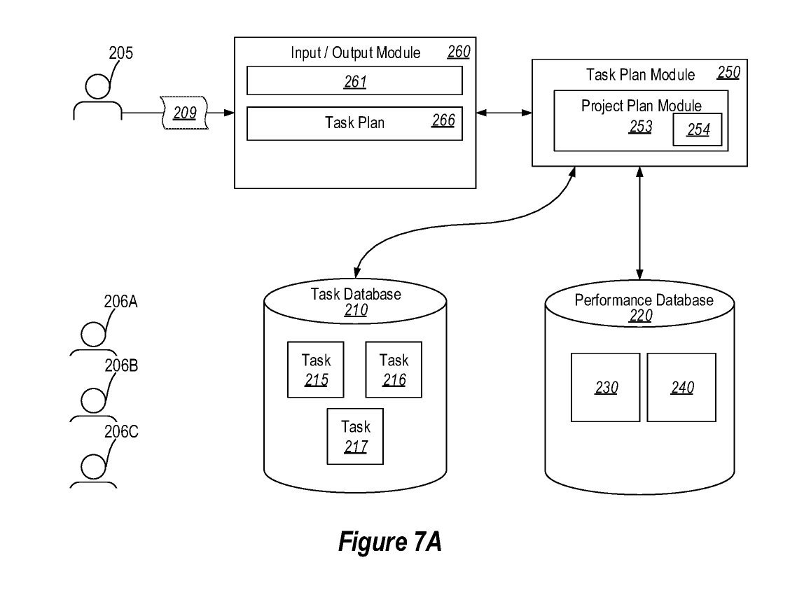

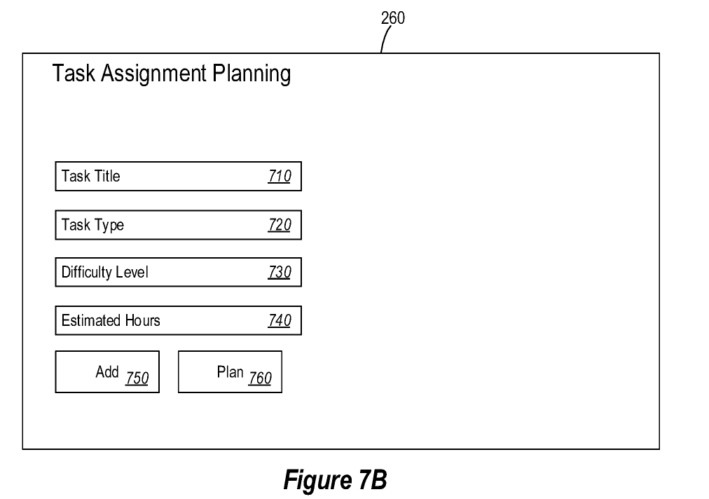

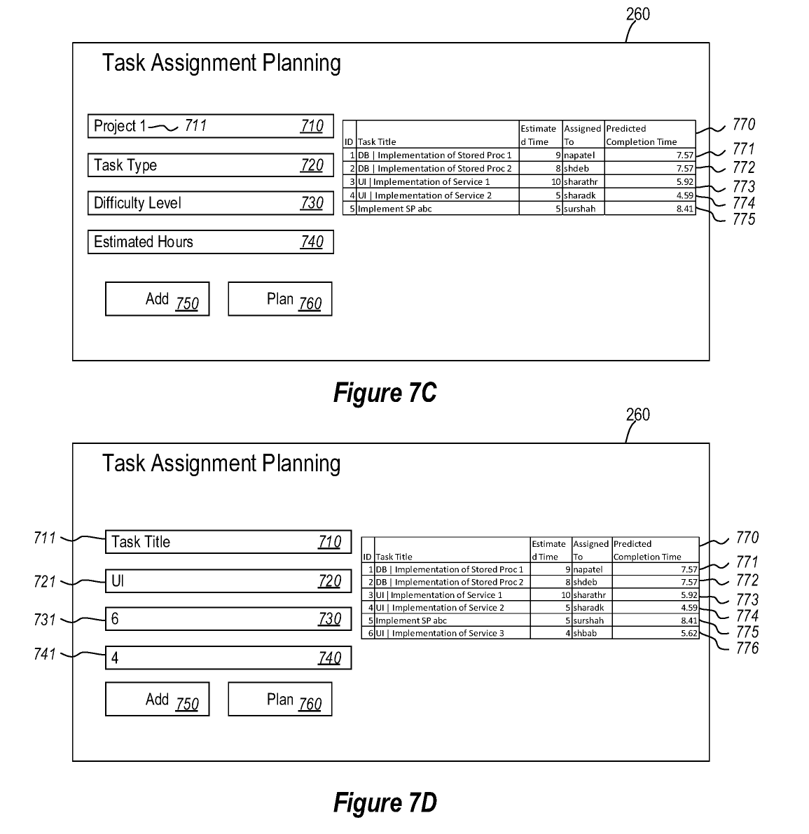

FIG. 7A illustrates an embodiment of the operation of the task plan module 250 in allocating the set of tasks to a group of the developers 206 who are best able to perform them based on the project plan 254. FIG. 7A illustrates a portion of the environment 200 and computing system 201 shown in FIGS. 2-4 and not all the details of those figures are included for ease of explanation.

As shown in FIG. 7A, the assigner 205 may desire to determine the group of developers 206 best suited to perform the task defined in the project plan 254. Accordingly, the assigner 205 may provide input 209 into the input element 261. In this embodiment, the input 209 may identify the project plan 254.

The input element 261 may then provide the input 209 to the task plan module 250, specifically to the project plan module 253. The project plan module 253 may then access or receive the task description information for the types of task specified in the project plan 254 from the task database 210. In the embodiment, since there may be any number of tasks included in the project plan 254, all of or any subset of the task information for the tasks 215-218 may be accessed or received. In addition, the project plan module 253 may access or receive the developer information 230 and the past performance information 240 for each of the developers 206.

The project plan module 253 may then compare or otherwise analyze the developer information 230 and the developer past performance information 240 in view of the various tasks listed in the project plan 254. In this way, the project plan module 253 is able to determine, for each individual task listed in the project plan 254, the developer 206 that has the expertise level and/or the past experience to perform each task, given the task's specified difficulty. Thus, the project plan module 253 is able to determine a group of developers 206 best suited to perform each task of the project plan 254. The project plan module 253 may also access the current workload information of the best suited developers 206 to ensure that these developers are currently able to take on a new or additional task assignment. It will be appreciated that the project plan module 253 may perform any reasonable operation, algorithm, or the like to determine the developers 206 who should perform the tasks of the project plan 254.

The determination of the developers 206 who should perform the tasks of the project plan 254 is an example of current performance estimation parameter. As shown in FIG. 7A, this may be output and displayed on a UI of the input/output module 260 as project allocation plan 266.

Attention is now given to FIGS. 7B-7D, which illustrate an embodiment of the input/output module 260 and the operation of the project plan module 253. As illustrated in FIG. 7B, the input/output module 260 include various input elements 261. For example, the figure includes an element 710 for inputting an identifier of the project plan 254, an element 720 for inputting a type of a task 215-218, an element 730 for inputting a difficulty level for the inputted task, and an element 740 for inputting an estimated time to complete the inputted task. An element 750 is used to add the inputted task to the project plan 254 and an element 760 that is used to cause the project plan module 253 to determine the group of developers 206 best suited to perform each task of the project plan 254.

FIG. 7C shows an example of the assigner 205 inputting the input 209 into the input/output module 260. For example, the name of the project plan 254, which in the embodiment is “Project 1”, is input. The assigner 205 may then activate the element 760, which causes the project plan module 253 to determine the group of developers 206 best suited to perform each task of the project plan 254 in the manner previously described.

As shown in FIG. 7C, this results in a project allocation plan 770, which is an example of a project allocation plan 266. The project allocation plan 270 includes entries 771-775. Each of the entries in the project allocation plan 266 list a task ID, a description of the task and its task type, an estimated time for the completion of the task, the identity of the developer 206 best suited to perform the task, and the predicated actual time that it should take for the completion of the task. For example, entry 771 shows an ID of “1”, a task type of “UI” and a description of “implementation of stored Proc 1”, an estimated time of 9 hours, the alias “napatel” of the developer 206 best suited to perform the task, and a predicted time of 7.57 hours. Entry 772 shows an ID of “2”, a task type of “DB” and a description of “implementation of stored Proc 2”, an estimated time of 8 hours, the alias “shdeb” of the developer 206 best suited to perform the task, and a predicted time of 7.57 hours. Entry 773 shows an ID of “3”, a task type of “UI” and a description of “implementation of Service 1”, an estimated time of 10 hours, the alias “sharathr” of the developer 206 best suited to perform the task, and a predicted time of 5.92 hours. Entry 774 shows an ID of “4”, a task type of “UI” and a description of “implementation of Service 2”, an estimated time of 5 hours, the alias “sharadk” of the developer 206 best suited to perform the task, and a predicted time of 4.59 hours. Entry 775 shows an ID of “5”, a task type of “MT” and a description of “implement SP abc”, an estimated time of 5 hours, the alias “surshah” of the developer 206 best suited to perform the task, and a predicted time of 8.41 hours.

In some embodiments, the assigner 205 may need to add a task to the project plan 254. Accordingly, the assigner is able to use the elements 720-750 to make the additions. As shown in FIG. 7D UI is input as the type as shown at 721, 0.5 is input as the difficulty level as shown at 731, and 4 is input as an estimated time for the completion of the task. The assigner 205 may then activate the element 750 to cause the project plan module 253 to add the task 721 to the project plan 254 and then to determine the best developer 206 suited to perform the newly added task. As shown in FIG. 7D, the project allocation plan 770 is then updated to include an additional entry 776. The entry 776 shows an ID of “6”, a task type of “UI” and a description of “implementation of Service 3”, an estimated time of 4 hours, the alias “shbab” of the developer 206 best suited to perform the task, and a predicted time of 5.62 hours.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

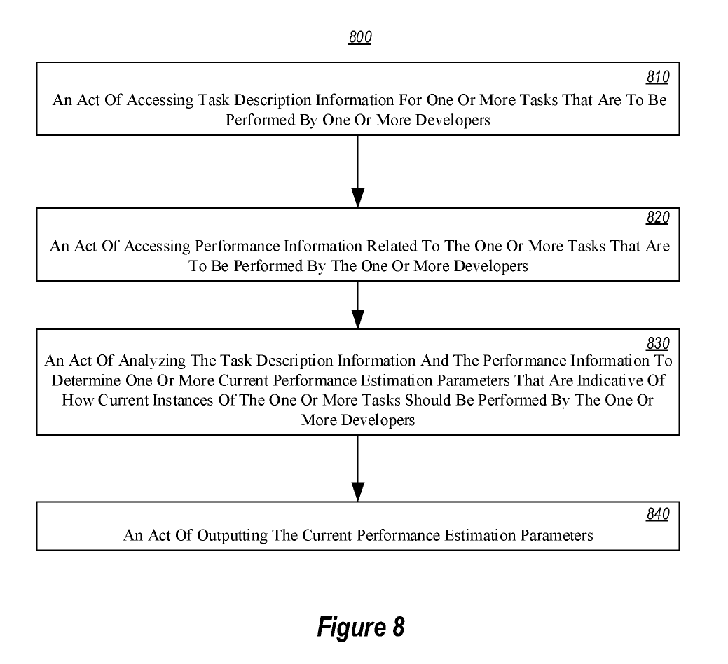

FIG. 8 illustrates a flow chart of an example method 800 for efficiently planning for the performance of one or more tasks of an overall project that members of a project team are to complete when implementing the project. The method 800 will be described with respect to one or more of FIGS. 2-8 discussed previously.

The method 800 includes accessing task description information for one or more tasks that are to be performed by one or more developers (act 810). For example, as previously discussed the task plan module 250 may access or receive from the task database 220 the task description information for the tasks 215-218 that are to be performed by the developers 206. In some embodiments, the task description information may specify the task type for the task, a difficulty level for the task, and any other reasonable information. The difficulty level may be specified as a range from 0-1 in some embodiments.

The method 800 includes accessing performance information related to the one or more tasks that are to be performed by the one or more developers (act 820). For example, as previously discussed the task plan module 250 may access or receive from the performance database 220 the developer information 230 and the developer past performance information 240 for the developers 206. In some embodiments, the developer information 230 may include an experience level that a developer has for a given task and may include a current workload of the developer. The developer past performance information 240 may include estimated time and actual time for the past performance of task 215-218, the identity of the assigner 205 who assigned the task, and any bug fix time.

The method 800 includes analyzing the task description information and the performance information to determine one or more current performance estimation parameters that are indicative of how current instances of the one or more tasks should be performed by the one or more developers (act 830). For example, as previously discussed the time prediction module may use the task description information 220 and the performance information 230 and 240 to determine a predicted time 262, an assigner 205 bias 263, and/or bug fix time 264, all of which are examples of current performance estimation parameters. The task allocation module 252 may use the task description information 220 and the performance information 230 and 240 to determine the developer 206 who the task should be allocated or assigned to as shown by the task allocation 265. The allocation 265 is an example of a current performance estimation parameter. The project plan module 253 may use a project plan 254 and the task description information 220 and the performance information 230 and 240 to determine which tasks should be allocated or assigned to which developers 206 as shown by the task plan 266. The task plan 266 is an example of a current performance estimation parameter.

The method 800 includes outputting the current performance estimation parameters (act 840). For example, as previously discussed the current performance estimation parameters 262-266 may be output and displayed on the input/output module 260.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system for efficient planning for the performance of one or more tasks of an overall project that members of a project team are to complete when implementing the project comprising:
a first database configured to store task description information for one or more tasks that are to be performed by one or more developers
a second database configured to store performance information related to the one or more tasks that are to be performed by the one or more developers;
at least one processor; and
system memory having stored thereon computer-executable instructions which, when executed by the at least one processor, cause the following to be instantiated in the system memory:
a first module configured to:
access the task description information from the first database;
access the performance information from the second database;
analyze the task description information and the performance information to determine one or more current performance estimation parameters that are indicative of how current instances of the one or more tasks should be performed by the one or more developers; and
a second module configured to:
output the current performance estimation parameters.

2. The computing system of claim 1, wherein the first and second databases are the same database.

3. The computing system of claim 1, wherein the performance information specifies how the one or more developers has performed each of the one or more tasks during previous performances of the one or more tasks.

4. The computing system of claim 1, wherein the performance information specifies an experience level that the one or more developers has for performing each of the one or more tasks.

5. The computing system of claim 4, wherein the experience level is determined based on one of an experience scale or based on a number of times that the one or more developers has performed the one or more tasks.

6. The computing system of claim 1, wherein the performance information specifies one of an estimated time to complete the one or more tasks, an actual time that the performance of the one or more tasks was completed in a past performance, a current workload of the one or more developers.

7. The computing system of claim 1, wherein the performance information specifies an identity of the entity that assigned the one or more tasks to the one or more developers.

8. The computing system of claim 1, wherein the task description information specifies one of a task type for the one or more tasks and a difficulty level of the one or more tasks.

9. The computing system of claim 1, wherein the current performance estimation parameters comprise a predicted time that it will take to complete the current instance of the one or more tasks.

10. The computing system of claim 1, wherein the current performance estimation parameters comprise one of a bias of the entity that assigned the one or more tasks and an amount of time to complete a bug fix of the current instance of the one or more tasks.

11. The computing system of claim 1, wherein the current performance estimation parameters comprise the identity of the one of the one or more developers that should perform the current instance of at least one of the one or more tasks.

12. The computing system of claim 1, wherein the current performance estimation parameters are determined based on a project plan that specifies a sub-set of the one or more tasks, the performance estimation parameters comprising the identities of a sub-set of the one or more developers that should perform the current instances the sub-set of the one or more tasks specified in the project plan.

13. A method for efficient planning for the performance of one or more tasks of an overall project that members of a project team are to complete when implementing the project, the method comprising:
an act of accessing task description information for one or more tasks that are to be performed by one or more developers;
an act of accessing performance information related to the one or more tasks that are to be performed by the one or more developers;
an act of analyzing the task description information and the performance information to determine one or more current performance estimation parameters that are indicative of how current instances of the one or more tasks should be performed by the one or more developers; and
an act of outputting the current performance estimation parameters.

14. The method of claim 13, wherein the performance information specifies how the one or more developers has performed each of the one or more tasks during previous performances of the one or more tasks.

15. The method of claim 13, wherein the performance information specifies an experience level that the one or more developers has for performing each of the one or more tasks.

16. The method of claim 13, wherein the performance information specifies one of an estimated time to complete the one or more tasks, an actual time that the performance of the one or more tasks was completed in a past performance, a current workload of the one or more developers.

17. The method of claim 13, wherein the task description information specifies one of a task type for the one or more tasks and a difficulty level of the one or more tasks.

18. The method of claim 13, wherein the current performance estimation parameters comprise one or more of a predicted time that it will take to complete the current instance of the one or more tasks, a bias of the entity that assigned the one or more tasks, an amount of time to complete a bug fix of the current instance of the one or more tasks, and the identity of the one of the one or more developers that should perform the current instance of at least one of the one or more tasks.

19. The method of claim 13, wherein the current performance estimation parameters are determined based on a project plan that specifies a sub-set of the one or more tasks, the performance estimation parameters comprising the identities of a sub-set of the one or more developers that should perform the current instances the sub-set of the one or more tasks specified in the project plan.

20. A computer program product comprising one or more hardware storage devices having thereon computer-executable instructions that are structured such that, when executed by one or more processors of a computing system, configure a computing system to perform method for efficient planning for the performance of one or more tasks of an overall project that members of a project team are to complete when implementing the project, the method comprising:
accessing task description information for one or more tasks that are to be performed by one or more developers;
accessing performance information that specifies how the one or more developers has performed each of the one or more tasks during previous performances of the one or more tasks;
analyzing the task description information and the performance information to determine one or more current performance estimation parameters that are indicative of how current instances of the one or more tasks should be performed by the one or more developers; and
outputting the current performance estimation parameters.
